(19) United States
(12) Patent Application Publication
(10) Pub. No.: US 2026/0185741 A1
(43) Pub. Date: Jul. 2, 2026

(54) BUILDING INTEGRATED CLEAN ENERGY BASED ECOLOGICAL PLUS ENERGY BUILDING SYSTEM

(71) Applicant: UIF (University Industry Foundation), Yonsei University, Seoul (KR)

(72) Inventor: Seung-ho YOO, Seoul (KR)

(73) Assignee: UIF (University Industry Foundation), Yonsei University, Seoul (KR)

(21) Appl. No.: 19/428,926

(22) Filed: Dec. 22, 2025

(30) Foreign Application Priority Data
Dec. 26, 2024 (KR) 10-2024-0196784
Jul. 21, 2025 (KR) 10-2025-0098295

(51) Int. Cl. F24H 4/02; A01G 9/14; A01G 27/00; F24H 15/156; H02S 20/26

(52) U.S. Cl. CPC F24H 4/02; A01G 9/14; A01G 27/008; F24H 15/156; H02S 20/26

(57) ABSTRACT

A building integrated clean energy based ecological plus energy building system is disclosed. The disclosed building integrated clean energy based ecological plus energy building system comprises a heat pump that heats incoming water to generate heating water, a heat pump heating/cooling water apparatus equipped with a city-water inlet pipe, a domestic-water supply pipe, a heating-water supply pipe, and a heating-water return pipe; a heating-water distributor connected to the heating-water supply pipe that distributes the heating water into a radiant heating/cooling piping network consisting of floor-embedded pipes, wall-embedded pipes, or ceiling-embedded pipes; a heating-water collector that supplies the heating water that has passed through the radiant heating/cooling piping network to the heating-water return pipe; a city-water supply pipe connected to the city-water inlet pipe that supplies city water to the heat pump heating/cooling water apparatus; a cooling city-water direct-connection pipe that directly connects the city-water supply pipe and the heating-water distributor, allowing city water to be directly supplied to the radiant heating/cooling piping network to perform indoor radiant cooling during the summer season; and a domestic-water transfer pipe that connects the domestic-water supply pipe and the domestic-water usage point to supply domestic water from the heat pump heating/cooling water apparatus to the domestic-water usage point; and a shading-type photovoltaic power generation system that is configured to be installed in an eave-like form at a predetermined angle on the exterior wall of the building, utilizing electricity generated from solar energy to be stored in a battery or to operate the heat pump water heater to supply power necessary for the radiant heating/cooling system, while also having a shading function that blocks the indoor influx of sunlight to reduce the cooling load of the apartment.

### CROSS-REFERENCE TO RELATED APPLICATION

This application claims priority from Korean Patent Application Nos. 10-2024-0196784, filed on Dec. 26, 2024, and 10-2025-0098295, filed on Jul. 21, 2025, in the Korean Intellectual Property Office, and all the benefits accruing therefrom under 35 U.S.C. 119. The contents of each of the above applications are incorporated herein in their entirety by reference.

### BACKGROUND

### Field

The present invention relates to a clean energy production and natural energy utilization system utilizing architectural structures, and more specifically, to a multi-functional bifacial building integrated photovoltaic system as a shade (MB-BIPVS), photovoltaic thermal (PVT) exchange module, and to generate electricity using the semi-transparent photovoltaic panel exterior of a building-integrated smart farm. This electricity is used to operate a heat pump (including a geothermal heat pump) to produce hot water and cold water (ice) for direct use or to be stored in a hot water tank or cold water (ice) tank for heating, cooling, and hot water supply as needed. The system features a radiant cooling system utilizing the enthalpy of city water, along with the shading function of the building-integrated bifacial photovoltaic (MB-BIPVS) and photovoltaic thermal (PVT) exchange module, and a double-skin structure consisting of operable glass windows (opened in summer and closed in winter) with operable openings at the top and bottom of the inner wall to appropriately exchange indoor air, thereby saving energy by utilizing natural energy. On the rooftop, a building-integrated smart farm is constructed with a 50%-transmittance photovoltaic module exterior, where edible crops are cultivated. The water required for cultivation can be reused after being utilized in the building's radiant cooling system. In winter, the warm air from this greenhouse is introduced indoors for heating, and to bring fresh air into the interior, air is drawn in through an underground duct and introduced into the indoor space near the radiant cooling floor in a source flow ventilation manner, allowing for ventilation at the breathing level of the human body. This air is then automatically expelled outside by buoyancy effects, resulting in an economically viable and environmentally friendly ecological plus energy house (hereinafter referred to as “plus house”) with zero CO2 emissions at minimal cost, concerning a clean energy production and natural energy utilization system.

### Description of Related Art

Typically, a zero-energy building or CO2 emission zero house refers to a building constructed to enable users to live without or with minimal external energy supply by adopting high-performance insulation materials and high airtightness windows, or by producing energy on-site using solar, wind, geothermal, and other renewable sources. The plus house of the present invention signifies a sustainable ecological house that produces more energy than it consumes, with any surplus energy being supplied to neighboring houses, for example. Given that energy consumption in buildings has reached as high as 40% in many countries around the world, some major countries are already planning to mandate zero-energy buildings, with intentions to expand the scale and scope over time. Consequently, due to technological advancements, increased awareness of environmental risks, rising incomes and purchasing power, and efforts by governments to mandate eco-friendly building materials, the market for zero-energy buildings, which are eco-friendly structures in various regions of the world, is experiencing significant growth. On the other hand, despite the high energy consumption in multi-family residential buildings such as apartments, heating systems like boilers are necessarily installed and used for heating during the winter season. These heating systems primarily heat water with boilers during the winter, which is then used for floor heating, specifically hot water ondol heating (radiant heating), or for hot water (such as for showers). However, these conventional boiler heating systems require the use of fossil fuels (such as oil and gas) and are limited to use only during the winter season when heating is essential, making them unsuitable for cooling during the summer. In other words, these boiler heating systems provide only fragmented functionality based on the seasons, and since they cannot perform cooling functions during the summer, it has been inefficient to have to establish separate cooling systems, such as air conditioning, to cool indoor spaces.

### SUMMARY

The present invention is devised to solve the conventional problems as described above, and aims to provide a natural energy (water heat energy) utilization system that applies a radiant cooling system utilizing the enthalpy of city water. This system allows for direct flow of city water through the heating pipes using an existing boiler heating system during the summer, enabling radiant cooling, which not only reduces cooling costs but also minimizes unnecessary water waste. Furthermore, the invention includes a bifacial photovoltaic power generation system with shading functionality integrated into the exterior wall of the building, which prevents condensation on the cooling side caused by radiant cooling through its pure shading function. This system also enhances power generation performance compared to conventional vertically attached solar panels on walls. Additionally, a photovoltaic thermal exchange module is installed at the lower outer section of a double outer skin, spaced a certain distance from the inner wall on the south side, while an operable window is installed at the top. This setup effectively blocks sunlight from entering the building during summer through the shading photovoltaic module, while allowing sunlight to naturally enter the interior during winter, thereby efficiently utilizing natural energy. On the rooftop, a building-integrated smart farm is established, wrapped in a 50%-transmittance photovoltaic panel module, where the electricity generated can be utilized in necessary areas within the building. The locally produced crops from this farm can be supplied nearby, and the water required for cultivating these crops can first pass through the radiant cooling side of the building before being utilized. During winter days, warm air heated by solar energy is introduced into the interior to enhance heating efficiency, while a natural ventilation system using underground ducts creates a comfortable environment within the building. Thus, the invention aims to provide an ecologically comfortable and sustainable space by producing clean energy within the building while effectively utilizing natural energy. However, the objectives of the present invention are not limited to these aspects, and other purposes or effects that can be inferred from the means of solving the problems or the forms of implementation, even if not explicitly mentioned, are also included.

The building integrated clean energy based ecological plus energy building system of the present invention, aimed at achieving the aforementioned objectives, generates heating water by heating the incoming water and comprises a heat pump heating/cooling water apparatus equipped with a city-water inlet pipe, a domestic-water supply pipe, a heating-water supply pipe, and a heating-water return pipe; a heating-water distributor connected to the heating-water supply pipe that distributes the heating water to a radiant heating/cooling piping network consisting of floor-embedded pipes, wall-embedded pipes, or ceiling-embedded pipes; a heating-water collector that supplies the heating water that has passed through the radiant heating/cooling piping network to the heating-water return pipe; a city-water supply pipe connected to the city-water inlet pipe that supplies city water to the heat pump heating/cooling water apparatus; a cooling city-water direct-connection pipe that directly connects the city-water supply pipe and the heating-water distributor, allowing city water to be directly supplied to the radiant heating/cooling piping network to perform indoor radiant cooling during the summer; and a domestic-water transfer pipe that connects the domestic-water supply pipe and the domestic-water usage point to supply domestic water from the heat pump heating/cooling water apparatus to the domestic-water usage point. Additionally, the system includes bifacial photovoltaic panels installed in an eave-like form at a predetermined angle above the exterior wall glass windows of the building, based on the principle of traditional house eaves, which reduces the building's cooling load by more than 34% and improves electricity generation by more than 46% compared to vertical installation on the wall through shading-type bifacial photovoltaic power generation. The heated water is used to operate the heat pump to produce hot and cold water, which is then stored in hot and cold water tanks for additional use in heating, cooling, and hot water supply, while the eave function blocks the indoor influx of summer sunlight, thereby reducing the cooling load of the apartment.

The radiant heating and cooling system may be configured to further include a controller that, during the summer season, blocks the movement of city water from the city-water supply pipe to the city-water inlet pipe, and controls the flow path so that city water is directly supplied to the heating-water distributor through the cooling city-water direct-connection pipe, proceeding with indoor radiant cooling while passing through the radiant heating/cooling piping network, and then recovered by the heat pump heating/cooling water apparatus. During the winter season, the controller controls the flow path so that the heating water heated by the heat pump heating/cooling water apparatus is supplied to the heating-water distributor through the heating-water supply pipe, allowing it to pass through the radiant heating/cooling piping network to proceed with indoor radiant heating, and then recovered by the heat pump heating/cooling water apparatus.

The controller may be configured to control the flow path so that, during the summer season, the city water recovered by the heat pump heating/cooling water apparatus is supplied to the domestic-water transfer pipe through the domestic-water supply pipe for use as domestic water.

It may further comprise a cooling ventilation unit configured on a connecting flow path connecting the radiant heating/cooling piping and the heating-water collector, wherein during the summer season, city water moving through the radiant heating/cooling piping undergoes air-cooled heat exchange with the heating-water collector to perform radiant cooling ventilation for the indoor space.

A thermal-storage unit comprising a thermal-storage material that is installed on a heating-water supply flow path connecting the heat pump heating/cooling water apparatus and the heating-water distributor, and that absorbs heat from the heating water passing through the heating-water supply flow path to store thermal energy.

A photovoltaic module main body equipped with a photovoltaic panel that collects solar energy from the front, and an embedded pipe that is connected at one side to the city-water supply pipe and at the other side to the city-water inlet pipe, and is embedded in the photovoltaic module main body in close contact with the photovoltaic panel, allowing for heat exchange between the photovoltaic panel and the embedded pipe, such that the heat collected by the photovoltaic panel and the embedded pipe exchange heat to heat the city water flowing through the embedded pipe; may further be configured to include a photovoltaic heat-exchange module.

The shading-type photovoltaic power generation system comprises bifacial photovoltaic panels that can generate solar power from both the front surface and the rear surface, and the bifacial photovoltaic panels can be configured to be installed in an eave-like form inclined on the exterior walls of each floor of the building.

Among two bifacial photovoltaic panels that are vertically adjacent on the exterior wall of a building, a portion of sunlight incident on the front surface of the lower bifacial photovoltaic panel is reflected and incident on the rear surface of the lower bifacial photovoltaic panel, allowing for power generation to occur on both the front and rear surfaces of the two vertically adjacent bifacial photovoltaic panels.

An external cold-air introduction duct system may be further configured to introduce fresh air from the ground level of the building into the indoor space, passing through underground ducts below the freezing line, thereby creating fresh cool air.

A window with a double arrangement structure spaced apart at predetermined intervals is configured on the exterior wall of the building to block heat loss from the indoor space by warming the air through solar heat in winter, and a warm-air retention chamber that warms the indoor air is further configured. An opening is configured at the upper and lower parts of the interior side wall of the warm-air retention chamber to allow warm air in winter to flow into the indoor space due to buoyancy caused by density differences, thereby enabling the air in the indoor space to be warmed.

A rooftop smart farm composed integrally of a glass greenhouse is configured on the roof of the building, wherein the rooftop smart farm has an exterior made up of 50%-transmittance photovoltaic panel modules installed on 50% of the total area of the side walls and roof surface of the glass greenhouse. The rooftop smart farm is designed to utilize rainwater for the water required for cultivating crops or to use city water recovered after performing indoor radiant cooling. Additionally, the rooftop smart farm may be configured to include a warm-air introduction duct that allows indoor air heated by solar energy during the winter daytime to flow into the indoor space of the building beneath the rooftop smart farm, thereby facilitating indoor heating during the winter.

According to the above, the present invention is a system that enables radiant cooling to occur by passing city water, such as tap water, through radiant heating/cooling piping embedded in the walls, floors, and ceilings of a building, using only the enthalpy and water pressure of the city water. This system does not require additional cooling devices or cooling energy for building cooling, making it an eco-friendly and sustainable comfortable building cooling solution for climate change mitigation and adaptation. In particular, by configuring the system to use the city water used for radiant cooling as domestic water, it does not require additional water for domestic use, thus being very eco-friendly while significantly reducing cooling energy consumption. Furthermore, during the summer season, the invention performs cooling ventilation by exchanging heat between the city water used for radiant cooling and high-temperature indoor air in an air-cooled manner, thereby ensuring energy savings and indoor comfort, and enabling faster and more efficient indoor cooling. Additionally, the invention utilizes bifacial photovoltaic modules and comprises a shading-type photovoltaic power generation system configured in an eave-like form at a predetermined angle on the exterior wall of the building, which not only prevents condensation on the cooling side due to radiant cooling through its pure shading function but also improves power generation performance compared to conventional vertically attached solar panels on walls, resulting in a significant reduction in external energy use for the building due to increased power generation. Moreover, the various and beneficial advantages and effects of the present invention are not limited to the aforementioned content and can be more easily understood in the process of describing specific embodiments of the invention.

### BRIEF DESCRIPTION OF DRAWINGS

FIG. 1 is a diagram illustrating the operation control state of the radiant heating and cooling system for a plus house according to an embodiment of the present invention during the summer season.

FIG. 2 is a diagram illustrating the operation control state of the radiant heating and cooling system during the winter season according to the present invention.

FIG. 3 is a diagram showing the specific configuration of the thermal-storage unit illustrated in FIG. 1.

FIG. 4 is a diagram illustrating the shading-type photovoltaic power generation system among the clean energy production and natural energy utilization systems according to an embodiment of the present invention.

FIG. 5A is a diagram illustrating a state in which the bifacial photovoltaic panel is installed at a relatively larger inclination angle by using the angle adjustment means according to the present invention.

FIG. 5B is a diagram illustrating a state in which the bifacial photovoltaic panel is installed at a relatively smaller inclination angle by adjusting the angle adjustment means according to the present invention.

FIG. 6 is a diagram illustrating the control block diagram of the clean energy production and natural energy utilization system according to an embodiment of the present invention.

FIG. 7 is a diagram illustrating the radiant heating and cooling system according to another embodiment of the present invention.

FIG. 8A is a diagram showing a front-sectional configuration of the hydropower generation means illustrated in FIG. 7, including the impeller casing, the impeller, and the generator mounted above the casing.

FIG. 8B is a diagram showing a side view of the hydropower generation means, illustrating the structure of the impeller disposed inside the casing and the arrangement of the inlet and outlet through which city water flows.

FIG. 9 is a diagram illustrating the control block diagram of the clean energy production and natural energy utilization system according to another embodiment of the present invention.

FIG. 10 is a diagram for explaining another configuration of the clean energy production and natural energy utilization system for a plus house according to an embodiment of the present invention.

FIG. 11 is a schematic diagram additionally illustrating the heat exchange path through a bypass into the thermal storage unit.

FIG. 12 is a diagram illustrating an example of a blind-type photovoltaic module.

### DETAILED DESCRIPTIONS

The objectives, other purposes, features, and advantages of the present invention will be easily understood through the following preferred embodiments related to the attached drawings. However, the present invention is not limited to the embodiments described herein and may be embodied in other forms. Rather, the embodiments introduced here are provided to ensure that the disclosed content is thorough and complete, and that the concept of the present invention is sufficiently conveyed to those skilled in the art.

In this specification, when it is mentioned that one component is on another component, it means that it may be directly formed on the other component or that a third component may be interposed between them. Additionally, in the drawings, the thickness of the components is exaggerated for the effective explanation of the technical content.

The embodiments described in this specification will be explained with reference to the ideal examples shown in the cross-sectional views and/or plan views of the present invention. In the drawings, the thicknesses of the films and regions are exaggerated for the effective explanation of the technical content. Therefore, the form of the illustrated examples may be modified due to manufacturing techniques and/or allowable tolerances. Thus, the embodiments of the present invention are not limited to the specific forms depicted but also include variations in shape generated according to the manufacturing process. For example, the etched regions illustrated at right angles may have rounded or predetermined curvature shapes. Therefore, the regions illustrated in the drawings possess certain properties, and the shapes of the regions depicted in the drawings are intended to exemplify specific forms of the device's regions and are not meant to limit the scope of the invention. In various embodiments of this specification, terms such as “first” and “second” have been used to describe various components, but these components should not be limited by such terms. These terms are merely used to distinguish one component from another. The embodiments described and illustrated herein also include their complementary embodiments.

The terms used in this specification are for the purpose of describing the embodiments and are not intended to limit the present invention. In this specification, the singular form includes the plural form unless specifically stated otherwise in the context. The terms ‘comprises’ and/or ‘comprising’ as used in the specification do not exclude the presence or addition of one or more other components.

In describing the specific embodiments below, various specific details have been provided to further explain the invention and aid in understanding. However, readers with knowledge in this field will recognize that the invention can be utilized without these various specific details. In some cases, it is noted in advance that commonly known aspects that are not significantly related to the invention will not be described in order to prevent unnecessary confusion in explaining the present invention.

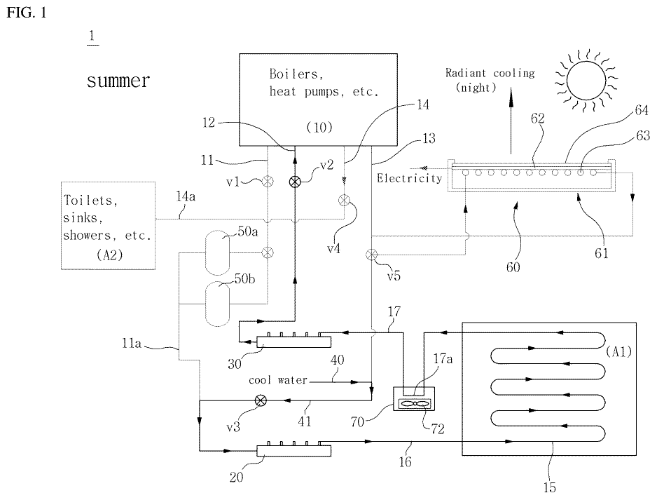

Hereinafter, with reference to FIGS. 1 to 6, the building-integrated clean energy production and natural energy utilization system according to one embodiment of the present invention will be described.

The building-integrated clean energy production and natural energy utilization system for the plus house of the present invention comprises a radiant heating and cooling system (1) that performs indoor radiant cooling and radiant heating using city water, a shading-type photovoltaic power generation system (2), a photovoltaic thermal (PVT) system, a double skin, and a rooftop semi-transparent PV smart farm, among others.

Here, “city water” typically refers to water supplied by water service providers (government, city, province, local government), and in this invention, “city water” is configured to include tap water, source flow, and the like. For example, in the case of South Korea, tap water is approximately 19 to 20° C., source flow is 12 to 17° C., while in Germany and Denmark, tap water ranges from 10 to 14° C., and in Turkey, it is around 18 to 19° C.

The radiant heating and cooling system (1) comprises a heat pump heating/cooling water apparatus (10) that receives city water to heat the city water and generate heating water, a heating-water distributor (20) that distributes the heated heating water supplied from the heat pump heating/cooling water apparatus (10) to a radiant heating/cooling piping network (15) consisting of floor-embedded pipes, wall-embedded pipes, or ceiling-embedded pipes, a heating-water collector (30) that circulates the radiant heating/cooling piping network (15) to recover the used heating water and supply it back to the heat pump heating/cooling water apparatus (10), a city-water supply pipe (40) that supplies city water to the heat pump heating/cooling water apparatus (10), and a city-water direct-connection pipe (41) that directly connects the city-water supply pipe (40) and the heating-water distributor (20).

The heat pump heating/cooling water apparatus (10) may be composed of a heat pump. Here, the heat pump heating/cooling water apparatus can be configured as a conventional heat pump water heater that utilizes the condensation heat generated during the process of compressing and circulating the refrigerant to heat water. The heat pump heating/cooling water apparatus operates based on the principles of a refrigeration cycle, applying the refrigeration cycle circulation principle in either a forward or reverse direction to perform the operation of heating water or cooling water. Such heat pump heating/cooling water apparatuses are known, and a detailed description is omitted.

By using the heat pump heating/cooling water apparatus (10), it can help efficiently produce cooling water needed for indoor cooling during the summer. In particular, when the heat pump is operated in conjunction with external renewable energy sources such as photovoltaic power generation, it can contribute to reliably lowering indoor temperatures while reducing the burden of electricity consumption. The cooling water generated by the heating/cooling water apparatus flows through the radiant heating/cooling piping embedded in the floor or walls, delivering cool air throughout the entire space. Meanwhile, in the winter, the hot water generated by the heat pump heating/cooling water apparatus can be supplied to the radiant heating system, gradually warming the indoor space. The radiant heat can be widely transmitted through the floor, walls, and ceiling, favorably increasing the perceived temperature and helping to reduce temperature variations throughout the space by dispersing the heat source. Additionally, operating the heat pump using surplus electricity during nighttime or electricity produced by photovoltaic power generation can provide certain advantages in terms of economic efficiency and energy independence.

The heat pump heating/cooling water apparatus (10) is equipped with a heating-water supply pipe (11), a heating-water return pipe (12), a city-water inlet pipe (13), and a domestic-water supply pipe (14). The heating-water supply pipe (11) is configured to connect with the heating-water distributor (20), and the heating-water return pipe (12) is configured to connect with the heating-water collector (30).

A heat pump is a device that transfers heat through changes in the state and pressure of a refrigerant, fundamentally consisting of a cycle that repeats four stages: compression, condensation, expansion, and evaporation. The first stage is the compression stage, where the refrigerant passes through a compressor, changing from a low-temperature, low-pressure gas state to a high-temperature, high-pressure gas state. During this process, the temperature of the refrigerant rises sharply, preparing it to release heat. The second stage is the condensation stage, where the high-temperature, high-pressure refrigerant moves to a condenser and transforms into a liquid state while releasing heat to the outside. This process is an exothermic process, where the refrigerant has a temperature higher than the surroundings and condenses into a liquid after transferring heat. The condensed refrigerant exists in a high-pressure liquid state. The third stage is the expansion stage, where the condensed refrigerant passes through an expansion valve, causing a rapid drop in pressure and expanding to a low-temperature, low-pressure state. During this process, the temperature of the refrigerant decreases, making it capable of evaporating. The refrigerant in this state moves to the evaporator. The fourth stage is the evaporation stage, where the refrigerant absorbs heat from an external heat source (for example, air, geothermal energy, or city water) in the evaporator, changing back into a gas. During the evaporation process, the refrigerant effectively absorbs thermal energy from the surrounding environment, and this gas returns to the compressor to repeat the cycle.

The heat pump system simultaneously forms high-temperature and low-temperature sections through the circulation of refrigerant, and the present invention proposes a structure that can independently and effectively utilize the thermal characteristics of both extremes. The waste heat generated in the high-temperature section is converted into domestic hot water through a separate heat exchanger, and this hot water can provide a significant energy-saving effect for hygiene purposes such as washing and showering. By storing and utilizing the heat that naturally occurs during the refrigerant's condensation process, it is possible to reliably supply the necessary heat source without a separate hot water heating device.

On the other hand, the low-temperature section of the heat pump is utilized as a heat source for cooling. The refrigerant in a low-temperature state absorbs and transfers heat into the indoor space in various forms, such as radiant floor cooling and heat exchangers for air conditioning, and in this process, the indoor temperature can be efficiently reduced. The refrigerant absorbs heat through heat exchange with external air or geothermal heat during the vaporization stage and is then recirculated, allowing the system to simultaneously perform cooling and hot water supply through a single refrigerant cycle.

As such, the present invention provides a high-efficiency thermal management system that enables bidirectional utilization of energy without waste by utilizing the high-temperature waste heat from the heat pump for domestic hot water and employing the heat absorption function on the low-temperature side for indoor cooling. This enhances the energy self-sufficiency of the entire system and realizes an integrated structure for heating, cooling, and hot water supply.

In addition, the city-water inlet pipe (13) is configured to connect with the city-water supply pipe (40), and the domestic-water supply pipe (14) is configured to connect with the domestic-water usage point (A2) through the domestic-water transfer pipe (14a).

In the present invention, valves are configured on each flow path to control the flow of fluid. Specifically, a heating-water supply valve (v1) is configured on the heating-water supply pipe (11), and a heating-water return valve (v2) is configured on the heating-water return pipe (12). Additionally, a cooling city-water supply valve (v3) is configured on the cooling city-water direct-connection pipe (41), and a domestic-water supply valve (v4) is configured on the domestic-water supply pipe (14), while a heating city-water supply valve (v5) is configured on the flow path connecting the city-water inlet pipe (13) and the city-water supply pipe (40). Furthermore, the present invention may also include a valve on the flow path (16) connecting the heating-water distributor (20) and the radiant heating/cooling piping network (15).

In the present invention, the radiant heating/cooling piping (15) installed on the indoor floor surface can be configured as capillary tubes. These capillary tubes, with a diameter of approximately 1 cm, can be arranged much more densely compared to conventional piping, thereby securing a larger heat exchange area within the same surface area. The capillary tubes enable uniform temperature distribution across the entire floor while controlling the water flow rate, contributing to precise control of radiant heating/cooling and improved energy efficiency.

The micro-tube is arranged at regular intervals on the upper surface of the indoor floor structure and is then embedded to a thickness of approximately 3 cm using an inorganic binder such as mortar or clay. This embedding method protects the tube from mechanical impact while maximizing the thermal conductivity efficiency between the floor surface and the tube. In particular, mortar or clay, being materials with high specific heat, can function as a cooling thermal storage medium, which is advantageous for ensuring the consistency and sustainability of cooling performance.

The system of the present invention may have a structure in which city water is intermittently supplied only during the time periods when the user uses water (for example, for washing hands, using the restroom, doing laundry, etc.). This intermittent supply of thermal media can induce energy savings; however, it may also cause unevenness in indoor temperature changes. Accordingly, the mortar embedded layer or the loess embedded layer acts as a thermal storage layer that stores the cooling energy of the intermittently introduced cold water, assisting in maintaining a certain level of cooling effect even during the user's absence.

These valves (v1 to v5) may be configured to be controlled by the valve control unit (91) of the controller (90).

In the present invention, the valve control unit (91) blocks the heating city-water supply valve (v5) during the summer season, while opening the cooling city-water supply valve (v3) and the heating-water return valve (v2). As shown in FIG. 1, city water is directly supplied to the heating-water distributor (20) through the city-water direct-connection pipe (41), and after circulating through the radiant heating/cooling piping (15) to achieve radiant cooling in the building interior, it can be supplied to the heat pump heating/cooling water apparatus (10) via the heating-water collector (30) and the heating-water return pipe (12).

After being used for radiant cooling in this manner, the city water supplied to the heat pump heating/cooling water apparatus (10) can be utilized at the domestic-water usage point (A2) by opening the domestic-water supply valve (v4).

Here, the domestic-water usage point (A2) refers to fixtures and devices that use domestic water, which may include toilet bowls, car wash spray nozzles, washing machines, showerheads, and kitchen sink faucets.

The radiant heating and cooling system (1) of the present invention, during the summer season, blocks the movement of city water from the city-water supply pipe (40) to the city-water inlet pipe (13) and directly supplies city water to the heating-water distributor (20) through the city-water direct-connection pipe (41), controlling the flow path so that it is recovered by the heat pump heating/cooling water apparatus (10) after performing indoor radiant cooling in the indoor radiant cooling area (A1) via the radiant heating/cooling piping (15). This method utilizes the low-temperature enthalpy of the city water supplied directly to the radiant heating/cooling piping (15) for radiant cooling purposes, and additionally allows the city water used for radiant cooling to be utilized as domestic water, thereby reducing the burden of operating a separate cooling device such as an air conditioner, while also preventing unnecessary waste of city water and enabling the implementation of a cooling system that requires no power at all.

On the other hand, in the radiant heating and cooling system (1) of the present invention, the heat pump heating/cooling water apparatus (10) can be configured in conjunction with MB-BIPVS, geothermal, and PVT, thereby enabling not only radiant cooling utilizing the enthalpy of city water but also applying the principle of a reversible heat pump by reversing the circulation direction of the refrigeration cycle of the heat pump heating/cooling water apparatus. This principle allows for the absorption of heat from the surrounding environment and its release to the outside, generating cold water, which can be utilized for indoor cooling functions.

The radiant heating and cooling system (1) of the present invention can be configured to operate with the heating function of a conventional heating system.

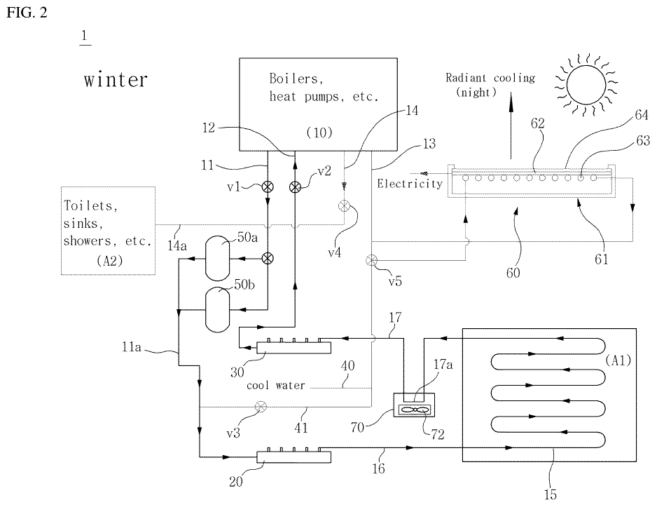

That is, during the winter season, the valve control unit (91) closes the cooling city-water supply valve (v3) and opens the heating city-water supply valve (v5) so that, as shown in FIG. 2, city water flows into the heat pump heating/cooling water apparatus (10) through the city-water inlet pipe (13), and the heating-water supply valve (v1) and heating-water return valve (v2) are opened to allow the heating water, heated to a predetermined temperature in the heat pump heating/cooling water apparatus (10), to proceed with indoor radiant heating for the indoor heating/cooling area (A1) while passing through the radiant heating/cooling piping network (15), and then be returned to the heat pump heating/cooling water apparatus (10).

The radiant heating and cooling system (1) is installed on a heating-water supply flow path (11a) that connects the heating-water supply pipe (11) and the heating-water distributor (20), absorbing and storing thermal energy from the hot water passing through the heating-water supply flow path (11a), and may further include a thermal-storage unit (50a) that enables the heating of water passing through the heating-water supply flow path (11a) using the stored thermal energy.

In addition, the radiant heating and cooling system (1) may further include a thermal-storage unit (50b) that is installed on a heating-water supply path (11a) connecting the heating-water supply pipe (11) and the heating-water distributor (20), which absorbs and stores cooling energy from the cold water passing through the heating-water supply path (11a), allowing for the cooling of the water passing through the heating-water supply path (11a) via the stored cooling energy.

That is, the thermal-storage unit (50a) stores thermal energy from the hot water generated by the heat pump heating/cooling water apparatus (10), and the cooling-storage unit (50b) stores cooling energy from the cold water generated by the heat pump heating/cooling water apparatus (10), such that water passing through the heating-water supply flow path (11a) is configured to either pass through the thermal-storage unit (50a) to be heated or pass through the cooling-storage unit (50b) to be cooled.

In other words, when the water passing through the heating-water supply flow path (11a) from the heat pump heating/cooling water apparatus (10) is lower than the thermal storage temperature of the thermal-storage unit (50a), it is configured to allow the heating water to be heated as it passes through the thermal-storage unit (50a).

Water passing through the heating-water supply flow path (11a) from the heat pump heating/cooling water apparatus (10) is configured to be cooled as it passes through the thermal-storage unit (50b) when the temperature of the water is higher than the cooling temperature of the thermal-storage unit (50).

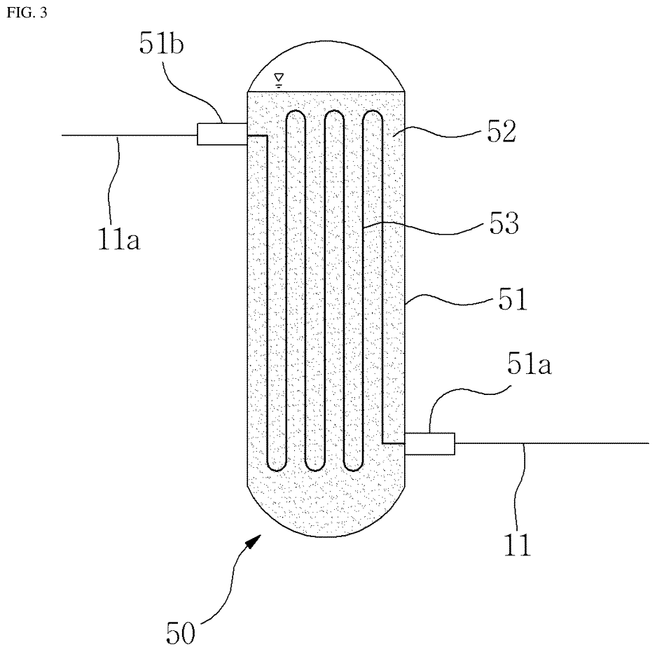

For example, the thermal-storage unit (50a) and the thermal-cooling storage unit (50b) are each connected to the heating-water supply pipe (11) as shown in FIG. 3, and include an inlet port (51a) through which water (hot water or cold water) supplied from the heat pump heating/cooling water apparatus (10) flows in, and an outlet port (51b) that is connected to the heating-water supply flow path (11a) and discharges heated or cooled water into the heating-water supply flow path (11a). They are composed of a thermal-storage tank (51) that houses a thermal-storage material (52) made of a heat transfer fluid or solid thermal-storage material, etc. Here, the thermal-storage material (52) is a material that can absorb and store thermal energy from hot water and can absorb and store cold energy from cold water.

When an additional thermal-storage unit (50a) is configured in this way, the heat pump heating/cooling water apparatus (10) can be operated to store heat in the thermal-storage unit (50a) using the high-temperature heating water supplied from the heat pump heating/cooling water apparatus (10). Subsequently, by allowing the heating water from the heat pump heating/cooling water apparatus (10) to be additionally heated by the thermal-storage unit (50a) without strongly operating the heat pump heating/cooling water apparatus (10) at high temperatures, the operating costs of the heat pump heating/cooling water apparatus (10) can be reduced.

Additionally, when an auxiliary thermal-storage unit (50b) is configured, the heat pump heating/cooling water apparatus (10) can be operated to store cold air in the thermal-storage unit (50b) using the low-temperature cooling water supplied from the heat pump heating/cooling water apparatus (10). Subsequently, by allowing the cooling water from the heat pump heating/cooling water apparatus (10) to be additionally cooled by the thermal-storage unit (50b) without strongly operating the heat pump heating/cooling water apparatus (10) at low temperatures, the operating costs of the heat pump heating/cooling water apparatus (10) can be reduced.

Additionally, for example, during the summer, city water supplied through the city-water supply pipe (40) can flow into the indoor heating and cooling area (A1) for cooling purposes. At this time, the city water can flow through one or more of the city-water direct-connection pipe (41) or the connecting flow path (16), and these flow paths may include a route that bypasses the interior of the thermal-storage unit (50b). Accordingly, the city water can pass through the low-temperature area of the thermal-storage unit (50b) and, through heat exchange with the cooling thermal-storage water cooled by a heat pump, can be reduced to a predetermined low temperature, for example, approximately 17° C. to 18° C., before being utilized for indoor cooling. This cooling method can be applied when the external temperature or the temperature of the city water is exceptionally high.

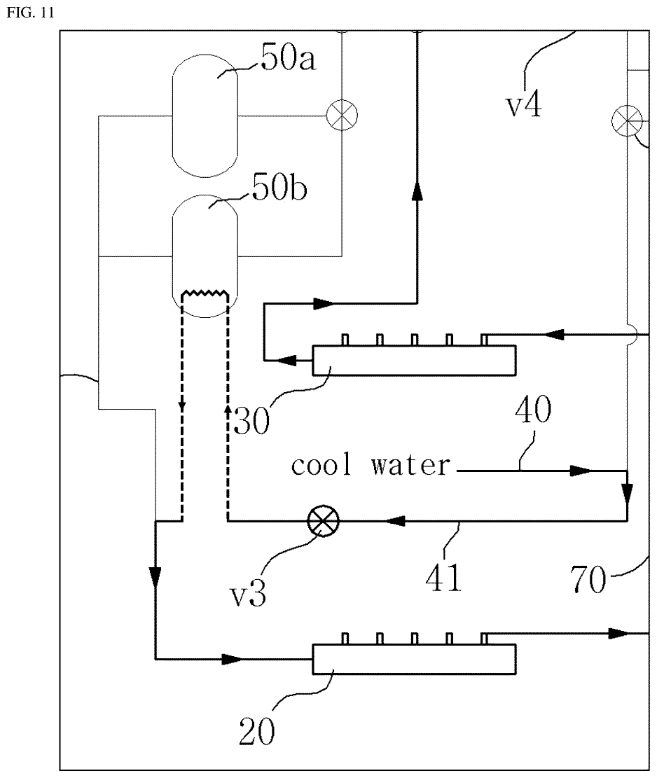

Furthermore, when cooling the indoor space through city water passing through the radiant heating/cooling piping (15) in the indoor heating and cooling area (A1), it does not limit the technical scope of the present invention; however, it is generally known that condensation issues do not occur when the city water is approximately between 17° C. and 18° C. Accordingly, even when the temperature of the city water introduced from outside is, for example, above 20° C., at least one of the city-water direct-connection pipe (41) or the connecting flow path (16) is configured to bypass the thermal-storage unit (50b), allowing for heat exchange with the low-temperature thermal-storage water stored in the unit, effectively lowering the temperature of the city water. FIG. 11 is a schematic diagram that enlarges the area around the thermal-storage unit (50b) from FIG. 1, additionally illustrating the heat exchange path through the aforementioned bypass. In FIG. 11, the city-water direct-connection pipe (41) is shown bypassing into the thermal-storage unit (50b), but this is illustrative; any piping before passing through the connecting flow path (16) or the radiant heating/cooling piping (15) can bypass the interior of the thermal-storage unit (50b) and facilitate heat exchange. Referring to FIG. 11, the bypass path additionally illustrated with a dotted line bypasses the interior of the thermal-storage unit (50b) and exchanges heat before proceeding in the direction of the radiant heating/cooling piping (15). Through this heat exchange process, the city water is adjusted to a suitable temperature (for example, 17° C. to 18° C.) for passing through the radiant heating/cooling piping (15), resulting in the indoor space achieving a comfortable radiant cooling effect with minimal energy input, even when the external temperature or the temperature of the city water is exceptionally high.

Meanwhile, although it does not limit the scope of the present invention, the city-water direct-connection pipe (41) or the connecting flow path (16) may be configured not merely to pass through the periphery of the thermal-storage unit (50b) or to mix directly, but rather to be inserted into it to enable substantial heat exchange. For example, the connecting piping may be inserted in a serpentine form that forms multiple bends or loops within the thermal-storage unit (50b) where low-temperature thermal-storage water is stored, thereby allowing the city water to be effectively cooled through non-mixing indirect heat exchange within the storage unit, even if it does not mix directly with the refrigerant or cooling water of the storage unit. This structural feature is advantageous for adjusting the city water to an appropriate temperature for radiant cooling, for example, around 17° C. to 18° C., and allows for precise adjustment of the cooling degree by controlling the flow rate of the city water. Consequently, even if the initial temperature of the incoming city water is high, it can be stabilized to a predetermined temperature through heat exchange while passing through the thermal-storage unit according to the present invention, and then supplied to the interior through the radiant heating/cooling piping (15), thereby achieving an efficient and comfortable radiant cooling effect that can be effectively applied in any region of the world.

Additionally, according to one aspect of the present invention, in cooling city water to a predetermined temperature through the non-mixed heat exchange structure as described above, a control means for maintaining a constant discharge temperature of the city water may be additionally included. Specifically, the object of the present invention may further include a flow control member that adjusts the flow rate of the city water and a temperature sensing member that senses the temperature of the city water discharged after undergoing a heat exchange process within the thermal-storage unit (50b). These members are configured to interlink signal-wise, automatically adjusting the flow rate according to the sensed discharge temperature, thereby reliably maintaining a predetermined target temperature suitable for radiant cooling (e.g., 17° C. to 18° C.). Such a control system provides a technical advantage by maintaining radiant cooling performance above a certain level, regardless of external environmental conditions or fluctuations in the initial temperature of the city water, thus achieving precise control of the indoor thermal environment and maximizing energy efficiency simultaneously.

Furthermore, the present invention utilizes inexpensive nighttime electricity during winter or electricity generated from photovoltaic (PV) power generation to drive a heat pump heating/cooling water apparatus (10) configured with a heat pump, thereby storing thermal energy in a thermal-storage unit (50a). During the daytime, the heat pump heating/cooling water apparatus (10) is not operated, and the heating water is allowed to pass through the thermal-storage unit (50a) to be heated before being supplied to the radiant heating/cooling piping (15), enabling indoor radiant heating using low-cost electricity and eco-friendly energy.

In addition, the present invention utilizes inexpensive nighttime electricity during the summer or electricity generated from photovoltaic (PV) power generation to drive the heat pump heating/cooling water apparatus (10) configured with a heat pump, thereby storing cold energy in the thermal-storage unit (50b). During the daytime, the heat pump heating/cooling water apparatus (10) is not operated, and the cooling water is allowed to pass through the thermal-storage unit (50b) to be cooled down before being supplied to the radiant heating/cooling piping (15), enabling indoor radiant cooling with low electricity costs and eco-friendly energy.

The present invention supplies city water directly to the heating-water distributor (20) during the summer, allowing the city water to flow directly into the radiant heating/cooling piping (15) to perform indoor radiant cooling for the indoor cooling and heating area (A1). In cases where the indoor cooling effect is insufficient due to this indoor radiant cooling utilizing the enthalpy of the city water, additional cooling water can be supplied from the heat pump heating/cooling water apparatus (10) to the thermal-storage unit (50b). The cooling water is then cooled using the thermal energy stored in the thermal-storage unit (50b) and flows through the heating-water distributor (20) into the radiant heating/cooling piping (15), thereby compensating for the inadequacy of indoor radiant cooling provided by the city water.

By using inexpensive electricity at night during the summer or solar power generation during the day, cold energy (cooling energy) is stored in the thermal-storage unit (50b) of the heat pump. Then, during the daytime, the stored cold energy in the thermal-storage unit (50b) is utilized to circulate cold water through the radiant heating/cooling piping network (15), thereby enhancing the efficiency of indoor radiant cooling and reducing electricity costs, or it may reduce carbon dioxide emissions by utilizing eco-friendly energy.

The radiant heating and cooling system (1) is installed on a flow path connecting the city-water inlet pipe (13) to the city-water supply pipe (40) and may further include a photovoltaic heat-exchange module (60) that preheats the city water supplied from the city-water supply pipe (40) to the heat pump heating/cooling water apparatus (10).

The radiant heating and cooling system (1) is installed on a flow path connecting the city-water inlet pipe (13) to the city-water supply pipe (40), and may further include a photovoltaic heat-exchange module (60) that can preliminarily heat the city water supplied from the city-water supply pipe (40) to the heat pump heating/cooling water apparatus (10) before supplying it. This photovoltaic heat-exchange module (60) may consist of a photovoltaic thermal (PVT) exchange module, which includes a photovoltaic module main body (61) equipped with a photovoltaic panel (62) that collects solar energy on the front surface, and an embedded pipe (63) that is connected between the city-water supply pipe (40) and the city-water inlet pipe (13) and allows for heat exchange in close contact with the photovoltaic panel (62). Additionally, to protect the photovoltaic panel from the external environment, a glass cover (64) may be additionally formed on the front surface of the photovoltaic module main body (61).

The photovoltaic heat-exchange module (60) comprises a photovoltaic module main body (61) equipped with a photovoltaic panel (62, PV panel) that collects solar energy from the front, and an embedded pipe (63) that is installed in close contact with the photovoltaic panel (62), one side of which is connected to a city-water supply pipe (40) and the other side is connected to a city-water inlet pipe (13), allowing for heat exchange with the photovoltaic panel (62). Additionally, the photovoltaic heat-exchange module (60) may further include a glass cover (64) for protecting the photovoltaic panel (62) on the front surface of the photovoltaic module main body (61).

The photovoltaic heat-exchange module (60) is structured to simultaneously promote photovoltaic power generation and thermal energy utilization, which can help alleviate the efficiency degradation issues associated with traditional photovoltaic panels to some extent. Typically, as the solar radiation increases, the surface temperature of the panel rises, leading to a gradual decrease in power generation efficiency. However, the photovoltaic heat-exchange module (60) of the present invention can be expected to lower the surface temperature of the panel to a certain level by transferring heat to city water through the embedded pipe (63) that is in close contact with the photovoltaic panel. This heat exchange process suppresses the temperature rise of the panel and can contribute to maintaining or improving the photovoltaic power generation efficiency in a stable manner.

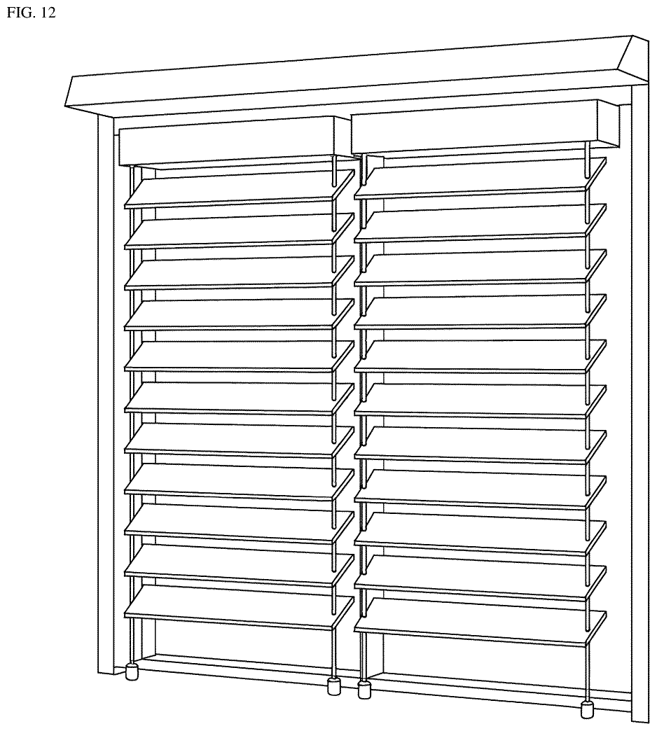

According to an embodiment of the present invention, the photovoltaic module main body (61) can be replaced with a blind-type photovoltaic module configured in an individual slat shape, in addition to a fixed panel structure. FIG. 12 is a diagram illustrating an example of such a blind-type photovoltaic module. This blind-type photovoltaic module has a plurality of slats arranged in parallel to each other, and the surface of each slat is composed of photovoltaic cells configured in either a single-sided or bifacial manner to perform a power generation function. Although FIG. 12 shows a plurality of slats arranged in parallel, this is illustrative, and slats arranged in a vertical or diagonal direction are not excluded from the scope of the present invention. The slats can be angle-adjusted according to user settings or changes in external environmental conditions, thereby achieving the dual purpose of maximizing power generation efficiency in response to changes in solar radiation and controlling the amount of light entering the indoor space.

In addition, the shading-type photovoltaic module can be applied to fully or partially replace the photovoltaic module main body (61) and can function as an auxiliary power generation means or solar radiation control means by being selectively arranged in the gap space between multiple photovoltaic module main bodies (61). This allows for an expansion of the spatial utilization and functional diversity of the photovoltaic system installed on the exterior of the building's exterior wall or openings (for example, windows and doors).

In addition, the blind-type photovoltaic module can be configured to move in a vertical or horizontal direction in conjunction with a sliding or rotating mechanism. This variable structure can actively respond to seasonal differences in solar altitude or changes in solar radiation by time of day, providing improved technical effects in terms of power generation efficiency, indoor environmental control, and architectural flexibility compared to fixed photovoltaic modules.

In addition, in the present invention, when a solar cell panel is installed in an eave-like form, a bifacial solar cell panel is used, and a heat exchange module capable of suppressing temperature rise is simultaneously employed, each component acts complementarily to produce a complex synergy effect in terms of power generation efficiency and energy utilization. The eave-like installation provides appropriate light collection conditions while adjusting indoor solar radiation according to the solar altitude, and the bifacial panel can increase power generation by utilizing incident light from both the front and rear surfaces. By combining this with the heat exchange module, it is possible to suppress overheating of the panel surface, thereby alleviating the phenomenon of decreased solar conversion efficiency, and at the same time, by utilizing the absorbed heat for indoor heating or hot water production, it can maximize the efficiency of the overall energy system.

The city water supplied from the city-water supply pipe (40) passes through the embedded pipe (63) and exchanges heat with the heat collected by the photovoltaic panel (62), causing the surface temperature of the photovoltaic panel (62) to decrease and improving the photovoltaic power generation efficiency of the photovoltaic panel (62). The city water passing through the embedded pipe (63) is heated, and the heated city water is then supplied to the heat pump heating/cooling water apparatus (10).

In this way, since the city water is not directly supplied from the cooling city-water supply pipe (40) to the heat pump heating/cooling water apparatus (10) but is preheated through the photovoltaic heat-exchange module (60) before being supplied to the heat pump heating/cooling water apparatus (10), the heat pump heating/cooling water apparatus (10) can heat the incoming city water to the set heating water temperature more quickly, thereby reducing the operating costs of the heat pump heating/cooling water apparatus (10).

In addition, the photovoltaic heat-exchange module (60) of the present invention can utilize a cooling function at night, where the photovoltaic panel (62) exchanges heat through cooling radiation with the cooled outdoor temperature, resulting in a decrease in the surface temperature of the photovoltaic panel (62). The water passing through the embedded pipe (63) can then exchange heat with the cooled photovoltaic panel (62), thereby achieving cooling.

The electric energy generated by the photovoltaic panel (62) of the photovoltaic heat-exchange module (60) may be used as power for the heating and cooling system, such as the heat pump heating/cooling water apparatus (10).

The present invention describes that the embedded pipe (63) of the photovoltaic heat-exchange module (60) connects the city-water supply pipe (40) and the city-water inlet pipe (13), such that the city water supplied from the city-water supply pipe (40) is heated by the photovoltaic heat-exchange module (60) and then supplied to the heat pump heating/cooling water apparatus (10) through the city-water inlet pipe (13). However, this is not limiting, and the city water supplied from the city-water supply pipe (40) may not necessarily pass through the photovoltaic heat-exchange module (60) but can be configured to be supplied directly to the city-water inlet pipe (13) and then immediately supplied to the heat pump heating/cooling water apparatus (10).

That is, as shown in FIG. 1 and FIG. 2, the city-water supply pipe (40) is branched to be directly connected to the city-water inlet pipe (13) or connected to the embedded pipe (63) of the photovoltaic heat-exchange module (60), and a heating city-water supply valve (V5) is formed at this connection branch, allowing the city water supplied from the city-water supply pipe (40) to be completely blocked from being supplied to both the city-water inlet pipe (13) and the embedded pipe (63), or to connect only one of the city-water inlet pipe (13) and the embedded pipe (63), thereby enabling selective supply of city water to either the city-water inlet pipe (13) or the embedded pipe (63) by controlling the flow path.

City water supplied from the city-water supply pipe (40) may be directly supplied to the city-water inlet pipe (13) instead of being supplied to the embedded pipe (63) of the photovoltaic heat-exchange module (60), allowing it to be used as drinking water when supplied to the heat pump heating/cooling water apparatus (10).

On the other hand, the radiant heating and cooling system (1) of the present invention is configured to further include a cooling ventilation unit (70) that performs radiant cooling ventilation for the indoor environment by heat exchanging city water, which has undergone radiant cooling through the radiant heating and cooling piping (15) during the summer season, in an air-cooled manner.

The cooling ventilation unit (70) is configured to include a cooling ventilation fan (72) that faces a portion (17a) of a flow path (17) connecting the radiant heating/cooling piping (15) and the heating-water collector (30).

During the summer season, when city water flows through the radiant heating/cooling piping network (15) to the heating-water collector (30) via the flow path (17) for radiant cooling, the cooling ventilation fan (72) blows air toward a portion (17a) of the flow path (17), allowing high-temperature air to exchange heat with the portion (17a) of the flow path (17) through which the city water flows, thereby cooling it. As a result, the temperature decreases, and the cooled air can be supplied into the indoor space, facilitating indoor cooling ventilation.

The cooled ventilated air, when introduced into the indoor space, naturally spreads out as it is cooler, settling into the lower areas. As this cold air lingers near the floor, when it comes into contact with the human body, the temperature of the air partially rises due to the relatively higher body temperature, resulting in an upward airflow that slowly carries the cold air upward along the body. This flow can deliver coolness to individuals through a direct sensation, distinct from radiant cooling, and can contribute to temperature regulation naturally without strong air currents, unlike air conditioning. In particular, this upward flow lifts only the necessary portion of the air surrounding the body to a height suitable for breathing, facilitating the direct intake of fresh air. Because localized ventilation is possible in this manner, there is no need to excessively cool or ventilate the entire space, allowing for both comfort and energy efficiency to be achieved simultaneously.

However, during the summer, the outdoor air often has a temperature exceeding 36° C. and a relative humidity exceeding 90%, which can hinder comfort and energy efficiency when directly introduced indoors. Therefore, it is necessary to appropriately control the physical state of the outdoor air when it is introduced for indoor ventilation, and to maintain a comfortable indoor environment, it is desirable to lower the temperature of the incoming air to a range of approximately 17 to 18° C. and to adjust the relative humidity to a level of 40 to 60%. The present invention has been devised based on this awareness of the problem, allowing for the simultaneous realization of thermal comfort and energy savings by pre-controlling the temperature and humidity of the outdoor air before supplying it indoors.

The cooling ventilation unit (70) of the present invention is configured to lower the initial temperature of the air to some extent by inducing relatively clean outside air through a duct buried underground, thereby introducing fresh air into the indoor space. However, this method has limitations as the temperature drop is restricted due to the thermal exchange effect of the ground, making it difficult to sufficiently lower the temperature to about 18° C., which is necessary for comfortable indoor conditions. Additionally, the relative humidity remains unchanged, making it challenging to control the humidity of the ventilated air. Accordingly, in the present invention, a thermal-storage unit (50b) that stores low-temperature cooling water generated by the heat pump heating/cooling water apparatus (10) is utilized to further cool and dehumidify the outside air, thereby effectively supplying air with controlled temperature and humidity to the indoor space.

As a specific solution, the present invention can apply a heat exchange method using capillary tubes. The capillary tubes have a significantly smaller diameter compared to conventional water supply piping, and multiple tubes are arranged in a web-like structure, which maximizes heat exchange efficiency. Additionally, the surface of the tubes is formed from metal or materials with excellent thermal conductivity, allowing for easy heat exchange with the air passing outside. In the present invention, low-temperature chilled water supplied from the heat pump heating/cooling water apparatus (10) is circulated within the capillary tubes, while outside the capillary tubes, outside air introduced through underground ducts flows, effectively lowering the temperature of the outside air. Furthermore, during this process, condensation occurs on the surface of the capillary tubes, which can reduce the absolute humidity of the outside air, thereby allowing for the control of not only the temperature of the incoming air but also its humidity at an appropriate level.

The cold water that passes through the heat pump heating/cooling water apparatus (10) is stored in the thermal-storage unit (50b), which is preferably positioned near the ground. This configuration allows for spatial proximity to a duct system (105) that induces a portion of the cooled outside air while passing through the ground, thereby maximizing the heat exchange efficiency with the capillary tube, which will be described later. In other words, the low-temperature cold water supplied from the thermal-storage unit (50b) flows through the capillary tube, and by placing this capillary tube on the outer wall of the outside air inlet duct or in its adjacent area, effective heat exchange can be achieved between the incoming air and the tube. In particular, since this heat exchange occurs intensively near the ground, it is possible to control not only the temperature of the outside air but also the humidity through the condensation formed on the surface of the capillary tube simultaneously.

In this way, the present invention not only supplies city water directly to the radiant heating/cooling piping (15) to perform radiant cooling, but also prevents the city water that has undergone radiant cooling from being supplied directly to the heat pump heating/cooling water apparatus (10). Instead, it allows for cooling ventilation to be performed through the cooling ventilation unit (70), thereby enabling faster cooling and improving cooling efficiency.

Furthermore, when the city water undergoes cooling ventilation through the cooling ventilation unit (70), the temperature of the city water is raised to a predetermined level due to heat exchange with high-temperature air. After this temperature-increased city water is supplied to the heat pump heating/cooling water apparatus (10), it is delivered to the domestic-water usage point (A2) through the domestic-water supply pipe (14) for use as domestic water, thereby allowing for the use of domestic water that is somewhat warmer than completely cold water.

The shading-type photovoltaic power generation system (2) is installed on the exterior wall of the building and is configured to supply the power required for the radiant heating and cooling system (1) by utilizing electricity obtained from solar power generation to operate the heat pump.

In the present invention, the shading-type photovoltaic power generation system (2) is characterized by being installed in an eave-like form, inclined at a predetermined angle on the exterior wall of a building, rather than being installed vertically in close contact with the exterior wall or on the rooftop of the building, thereby combining both power generation and shading functions.

The eave-type shading photovoltaic power generation system (2) can help block direct sunlight from entering the space below the eave due to the characteristic of the sun being nearly vertical during the high altitude of summer. As a result, the heat load entering the building's interior can be reduced, which can contribute to decreasing the energy consumption required for cooling. At the same time, the photovoltaic panel itself can effectively receive direct sunlight from above, thereby maintaining power generation efficiency. This structure allows for the efficient use of solar energy during periods of high cooling demand while keeping the indoor environment comfortable.

On the other hand, during the winter when the sun's altitude is low, sunlight entering at a low angle can naturally flow into the indoor space by passing diagonally through the lower space of the eave. Accordingly, it is expected that the indoor space can be partially heated by solar energy, which may help alleviate the heating load. Furthermore, if the photovoltaic panels are installed at an angle that can capture a certain amount of sunlight even during the low-altitude winter sun, a consistent level of power generation can be secured despite seasonal variations in solar conditions. This structure has the potential to contribute to energy self-sufficiency and improvement of the indoor environment by utilizing the sunlight conditions in winter.

That is, the shading-type photovoltaic power generation system (2) of the present invention is configured to be installed in an eave-like form at a predetermined angle on the exterior wall of the building, generating solar energy through solar cell panels (80), and utilizing the produced electricity as power for operating the heat pump, supplying it as the necessary power for the radiant heating and cooling system (1). Additionally, during the summer season, it serves a shading function by blocking the indoor influx of sunlight, thereby reducing the cooling load of the apartment during the summer. Through this shading function of the shading-type photovoltaic power generation system (2), it is expected that the cooling load can be reduced by 34% during the summer.

Furthermore, the electricity generated by the shading-type photovoltaic power generation system (2) of the present invention is not only used as a power source to operate the radiant heating and cooling system (1), but can also be utilized as various building operational power necessary for the operation of buildings such as apartments.

In particular, the photovoltaic panels (80) used in the shading-type photovoltaic power generation system (2) of the present invention may be composed of not only monofacial photovoltaic panels but also bifacial photovoltaic panels or may be configured as semitransparent.

The bifacial photovoltaic panel is a solar cell panel that can generate solar power through both sides of the panel, specifically the front surface and the rear surface of the solar cell panel. Some light is transmitted through the panel, incident on the solar cell surface located below, thereby increasing the power generation, and it can also allow natural light to enter indoors.

The bifacial photovoltaic panel (80) of the present invention is configured to be installed at a predetermined angle to perform a shading function by being mounted on wall brackets (81) installed on the exterior wall of the building for each floor.

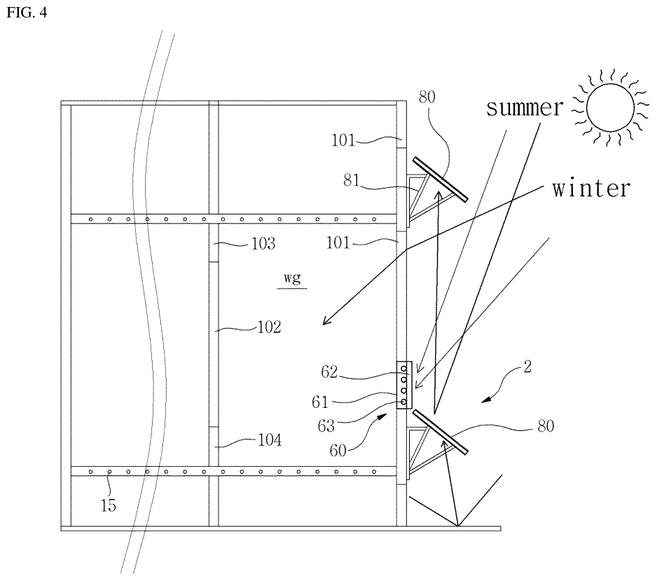

In this way, the bifacial photovoltaic panels (80) are configured on the exterior wall of the building to be spaced apart at predetermined intervals in the vertical direction for each floor. Accordingly, as shown in FIG. 4, a portion of the sunlight incident on the front surface of the upper bifacial photovoltaic panel (80) is reflected and incident on the rear surface of the lower bifacial photovoltaic panel (80), allowing for solar power generation to occur on the rear surface of the lower bifacial photovoltaic panel (80) as well, thereby increasing the amount of power generated.

In particular, in the present invention, by installing the solar cell panel in an eave-like form as described above and simultaneously using a bifacial solar cell panel, a synergistic effect can be expected through the organic combination of the two components. The inclined installation in an eave-like form effectively creates shading against the high angle of the summer sun while ensuring sufficient solar radiation on the front surface of the panel, and at the same time, allows reflected light to reach the rear surface of the lower panel, thereby creating an environment that can increase the power generation of the rear side of the bifacial panel. As a result, the solar energy collection efficiency can be improved compared to vertical installation with a single surface, and the shading function and power generation performance can act complementarily to achieve a dual effect of reducing cooling load and generating electricity simultaneously.

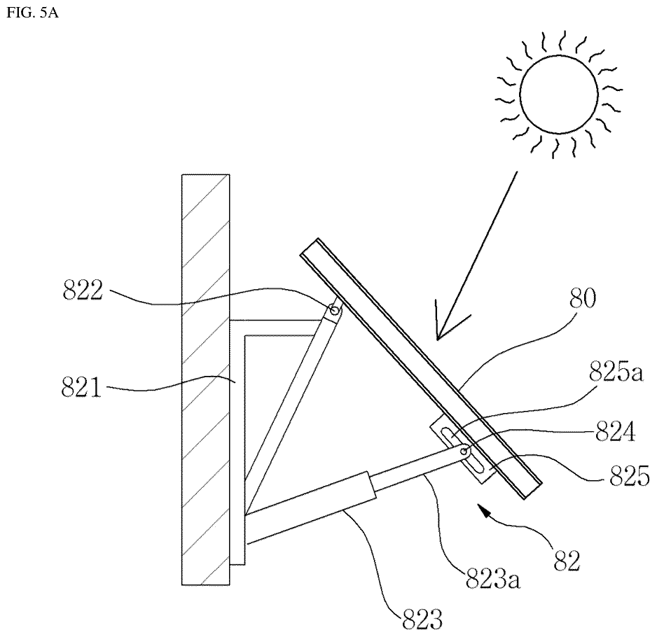

On the other hand, in the present invention, the photovoltaic panel (80) may be installed in a fixed form with a predetermined installation inclination angle as shown in FIG. 4, or, as shown in FIGS. 5A and 5B, it may be configured to allow adjustment of the installation inclination angle of the photovoltaic panel (80) through an angle adjustment means (82), thereby enabling the angle of incidence of sunlight incident on the photovoltaic panel (80) to be adjustable by season or time. FIG. 5A is a diagram illustrating a state in which the bifacial photovoltaic panel is installed at a relatively larger inclination angle by using the angle adjustment means according to the present invention. FIG. 5B is a diagram illustrating a state in which the bifacial photovoltaic panel is installed at a relatively smaller inclination angle by adjusting the angle adjustment means according to the present invention.

The angle adjustment means (82) comprises a bracket (821) installed on the exterior wall of the building, a hinge part (822) that rotatably connects the photovoltaic panel (80) to the upper side of the bracket (821), a cylinder module (823) installed at the lower end of the fixed bracket (821) that performs a telescopic motion, and a guide member (825) that is installed on the rear surface of the photovoltaic panel (80) and has a long hole-shaped sliding guide hole (825a) of a predetermined length, as well as a moving member (824) that is provided at the end of the telescopic bar (823a) of the cylinder module (823) and moves along the guide hole (825a) according to the telescopic motion of the cylinder module (823), pushing or pulling the photovoltaic panel (80) to adjust the angle of the photovoltaic panel (80).

In this way, the present invention may configure the installation inclination angle of the solar cell panel (80) in a fixed form; however, when configured to allow adjustment of the installation inclination angle of the solar cell panel (80) by the angle adjustment means (82), it will be possible to adjust the incident angle of sunlight incident on the solar cell panel (80) according to the position of the sun, which changes during the summer or winter seasons, or by time of day, thereby increasing the shading degree and the power generation from the solar cell panel (80).

Additionally, the bracket (821) may be installed as a fixed structure, but it can also be configured to allow for sliding movement in the vertical direction as needed. In this case, the bracket (821) is combined with a vertical guide rail or sliding track on the exterior wall of the building, enabling vertical movement. This allows the mounting position of the photovoltaic panel (80) itself to be adjusted upward or downward. As a result, the photovoltaic panel (80) can not only adjust its angle but also variably adjust its installation height, allowing for flexible adaptation to various environmental conditions.

With the addition of the height adjustment function of the solar cell panel (80) as described above, it is possible to achieve more precise solar radiation optimization even in environments where the altitude of the sun varies according to the time of day or season. In particular, during periods when the sun is at a high altitude, such as in summer, the position of the panel can be lowered to increase the shaded area, while in winter, the panel can be moved upward to maximize sunlight exposure. As a result, the energy efficiency of the building is improved, contributing to a reduction in heating and cooling burdens.

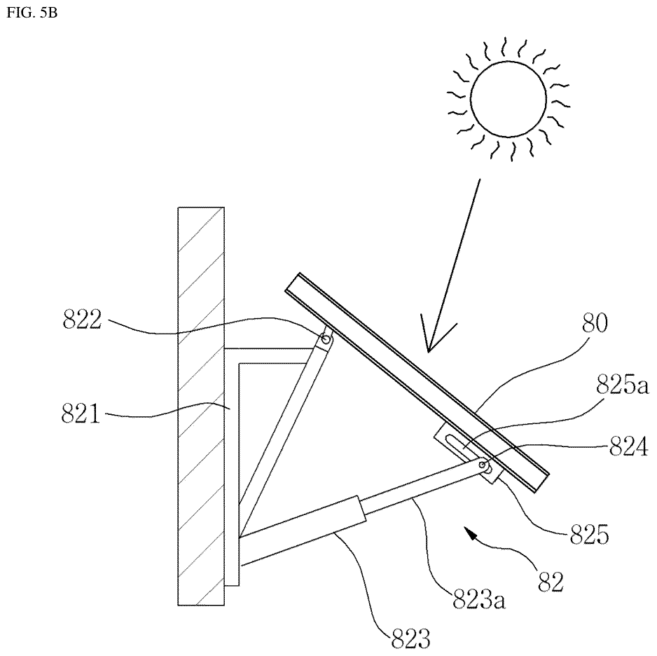

Referring to FIG. 6, the present invention may further comprise a battery (114) that charges and stores electricity generated through the solar cell panel (80), and it can be configured to supply power required for the valves (v1 to v5), the cylinder module (823) of the angle adjustment means (82), the cooling ventilation fan (72), the heat pump heating/cooling water apparatus (10), and the like with the power stored in the battery (114).

In this case, the controller (90) in the present invention may further include a charging controller (92) that controls the charging of electricity produced by the solar cell panel (80) to the battery (114).

The present invention can charge electricity produced by photovoltaic power generation, such as from a photovoltaic heat-exchange module (60) and a solar cell panel (80), into a battery (114) for later use as power for the building's heating and cooling system. If a battery (114) is not included, the electricity generated by photovoltaic power can be used to operate a heat pump heating/cooling water apparatus (10) to store thermal energy or cooling energy in a thermal-storage unit (50a) and a cooling-storage unit (50b), which can then be utilized as a source of heating and cooling energy.

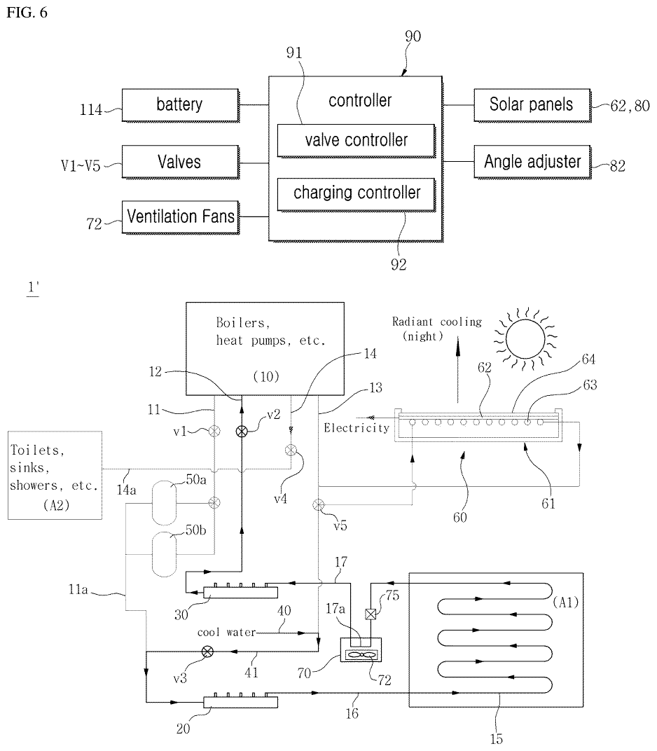

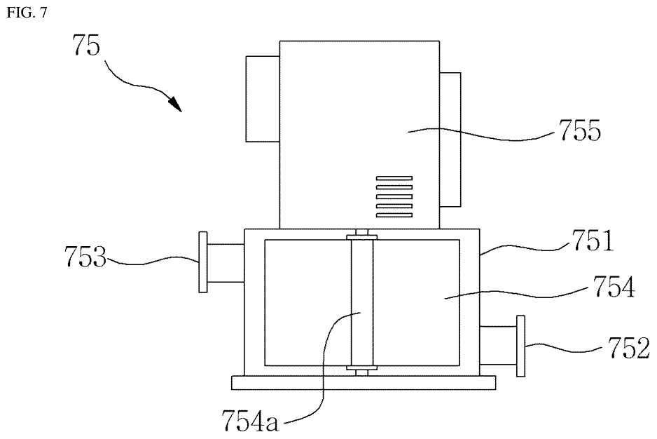

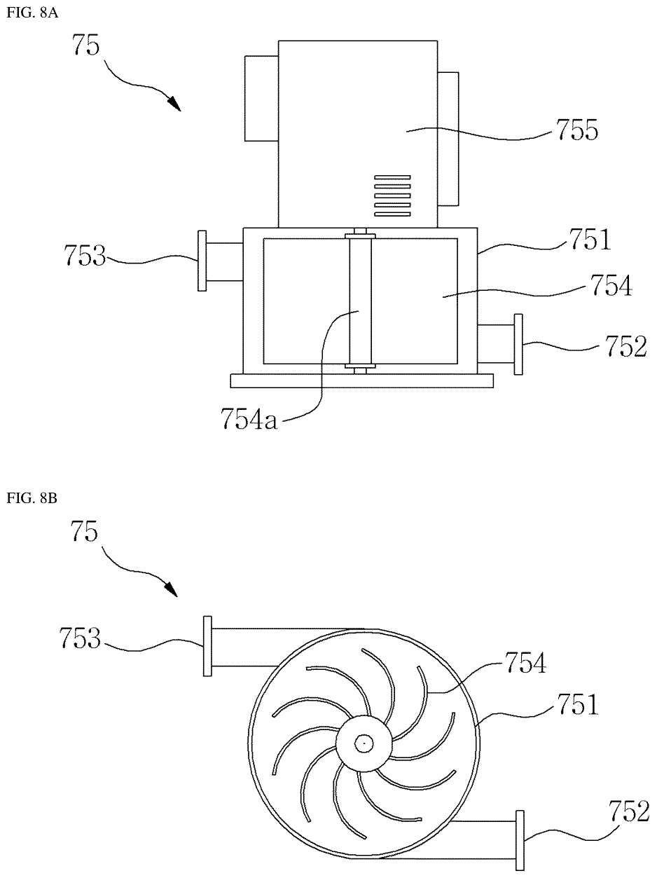

With reference to FIGS. 7 to 9, a clean energy production and natural energy utilization system for a plus house according to another embodiment of the present invention will be described.

The radiant heating and cooling system (1) of the clean energy production and natural energy utilization system (1′) according to this embodiment differs only in that it further includes a small hydropower generator (75) for supplying driving power to the cooling ventilation fan (72), compared to the radiant heating and cooling system (1) illustrated in FIG. 1 and FIG. 2; all other configurations are the same.

Accordingly, in the radiant heating and cooling system (1) of this embodiment, the same reference numerals are assigned to the same components as those in the radiant heating and cooling system (1) according to one embodiment shown in FIG. 1 and FIG. 2, and the description is omitted, with explanations provided only for the components that differ.

The small hydropower generator (75) is installed on a flow path (17) connecting the radiant heating/cooling piping (15) and the heating-water collector (30), and is configured to generate electricity by rotating due to the flow of city water flowing through the flow path (17).

The small hydropower generator (75) comprises an impeller casing (751) having an inlet (752) through which city water flows in and an outlet (753) through which city water is discharged; an impeller (754) that is rotatably installed inside the casing (751) and rotates due to the fluid flow of city water that enters the casing (751) through the inlet (752) and is discharged through the outlet (753); and a generator (755) that is installed at the upper part of the impeller casing (751) and configured to be connected to the rotation shaft (754a) of the impeller (754), thereby generating electricity in accordance with the rotation of the impeller (754).

The electricity produced by the small hydropower generator (75) is configured to be charged to the battery (114) by the charging control unit (92), and the controller (90) can control the supplied power charged to the battery (114) to operate the cooling ventilation fan (72).

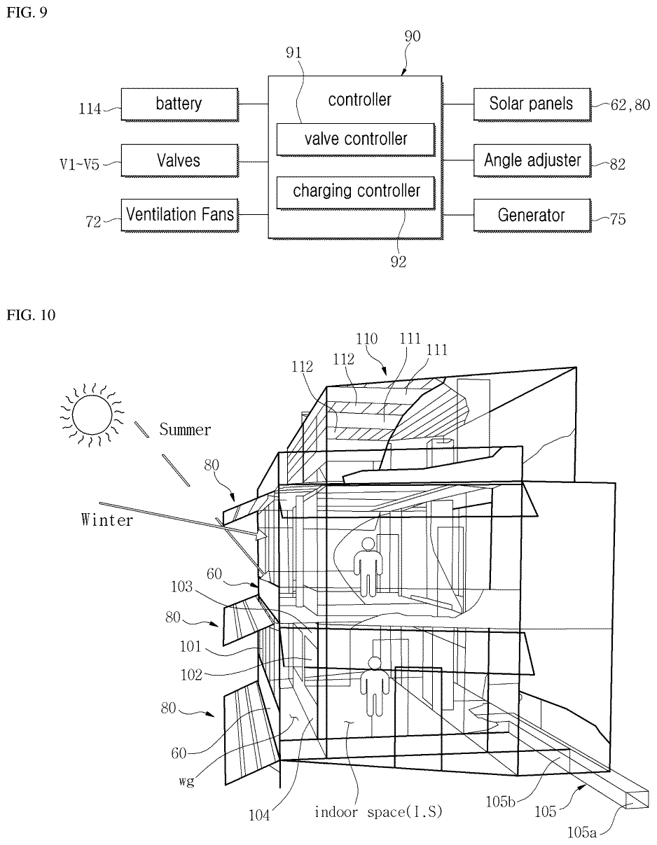

On the other hand, referring to FIG. 4 and FIG. 10, the present invention can configure windows with a double arrangement structure spaced apart at predetermined intervals on the exterior wall of a building such as an apartment, thereby blocking heat loss from the indoor space (I.S) by heating the air with solar energy during winter and additionally forming a warm-air retention chamber (wg) that warms the indoor air.

In other words, a movable outer window (101) is configured on the outermost exterior wall of the building, and an inner window (102) is arranged at a predetermined distance inward from the outer window (101), thereby forming a warm-air retention chamber (wg) in the space between the outer window (101) and the inner window (102). This warm-air retention chamber (wg) can function as a greenhouse in winter, as the air is warmed by sunlight, and it not only prevents the warmth of the indoor space (I.S) from being released to the outside but also allows the warm air from the warm-air retention chamber (wg) to flow into the indoor space (I.S) through the upper opening (103) and enables the cold air from the bottom of the indoor space (I.S) to flow into the warm-air retention chamber (wg) through the lower opening (104). This principle allows warm air to enter the indoor space (I.S) due to buoyancy caused by density differences, thereby warming the air in the indoor space (I.S) and significantly enhancing the utilization of natural energy, insulation performance, and heat retention performance for the indoor space (I.S). Here, since the warm-air retention chamber (wg) functions as a greenhouse during the winter, it can be named a winter garden, and the upper and lower openings may be automatically controlled to open and close based on the indoor temperature and the temperature of the winter garden.

A building-integrated rooftop smart farm (110) is configured on the roof of the building, wherein this smart farm (110) is constructed with a 50%-transmittance photovoltaic (PV) panel module (112) as its exterior, allowing the indoor space of the smart farm (110) to produce local agricultural food products for use by residents in the area.

The 50%-transmittance photovoltaic (PV) panel module (112) refers to a configuration in which photovoltaic panels are installed over 50% of the total surface area of the exterior skin of the side walls and roof of the rooftop smart farm (110).

That is, the rooftop smart farm (110) is composed of a glass greenhouse with both side walls and roof surfaces made of transparent glass panels, and the 50%-transmittance photovoltaic (PV) panel module (112) is installed at predetermined intervals on the exterior of the side walls and roof surfaces of the glass greenhouse that constitutes the rooftop smart farm (110), arranged in an alternating manner with the transparent glass portion (111) of the glass greenhouse, or it may be composed of a semi-transparent integrated PV module with approximately 50% transmittance.

In this case, the 50%-transmittance photovoltaic (PV) panel module (112) is configured to cover 50% of the total area of the side walls and roof surface of the rooftop smart farm (110) made of a glass greenhouse, such that 50% of the outer surface area of the rooftop smart farm (110) is exposed to the outside with transparent glass panels, while the remaining 50% is covered by the photovoltaic panel module. Solar energy can enter the rooftop smart farm (110) through the 50% exposed transparent glass panels, allowing for crop cultivation, and the remaining 50%-transmittance photovoltaic (PV) panel module (112) is configured to generate electricity from solar energy. Additionally, it can be composed of bifacial photovoltaic modules to enhance its performance.

The present invention exemplarily uses a 50%-transmittance photovoltaic panel module; however, it is not limited to this and various semi-transparent or multilayer structure photovoltaic panel modules with a transmittance adjusted within the range of 30% to 70% can also be applied. The selection of transmittance may vary depending on the photosynthetic characteristics of the crops, the solar radiation conditions of the region, and the seasonal light environment, and it can be designed considering a balance point that secures the necessary light for crop growth while also ensuring power generation efficiency. For example, in areas with strong sunlight, modules with lower transmittance can be used, while in areas with insufficient sunlight, modules with higher transmittance can be utilized for optimization. Therefore, the technical concept of the present invention can be flexibly applied to various configurations of transmittance photovoltaic panels.

In addition, the electricity generated from the 50%-transmittance photovoltaic (PV) panel module (112) that constitutes the exterior of the rooftop smart farm (110) can be utilized in various locations within the building mentioned earlier. The resulting synergy not only contributes to increasing the overall energy self-sufficiency of the building but can also lead to reduced operating costs for key facilities such as the radiant heating and cooling system, heat pump heating/cooling water apparatus, and ventilation fan module. In particular, the simultaneous cultivation of crops and power generation within the same structure enhances the efficiency of space utilization and can provide an additional function of reducing rooftop thermal load due to sunlight blocking effects. As a result, a foundation is established for an integrated and sustainable building operation system where agricultural production, energy generation, and indoor environmental control are organically connected.

Furthermore, the present invention allows for the water required for the rooftop smart farm (110) to be utilized by using rainwater, or when rainwater is insufficient, city water can be passed through the building's radiant cooling surface for cooling, after which this water can be used for crop cultivation. When this method of water recycling is organically combined with the energy-related facilities of the present invention, it can induce a complex synergy effect by forming a circular structure of energy and resources. For example, after the city water used in radiant cooling absorbs indoor heat and performs the cooling function, it can be directly supplied to the farm for crop growth, thereby completing a structure where the two systems of cooling and agriculture are integrated and operated within a single water system. This approach maximizes energy utilization at each stage without overlapping consumption of water and energy, resulting in a significant improvement in the overall energy efficiency of the building.

That is, in the present invention, the radiant cooling using city water directly supplies city water to the heating-water distributor (20) through the city-water direct-connection pipe (41), circulating it through the radiant heating/cooling piping network (15) to perform radiant cooling in the indoor space of the building. After performing the radiant cooling, the city water is supplied and used at domestic-water usage points (A2) such as toilets, car wash spray nozzles, washing machines, showers, and kitchen sink faucets. At this time, the city water that has undergone radiant cooling is supplied not only to the domestic-water usage points (A2) but also to the rooftop smart farm (110) for use in crop cultivation.

Accordingly, the domestic-water usage point (A2) may include not only the toilet, car wash spray nozzle, washing machine, shower, and kitchen sink faucet, but also the water supply for cultivating crops in the rooftop smart farm.

In addition, the present invention can configure an external cold-air introduction duct system (105) that introduces fresh air from the ground level of the building into the indoor space (I.S) while passing through underground ducts below the freezing line, thereby creating fresh cool air.

The external cold-air introduction duct system (105) is configured such that the air inlet (105a) is positioned at ground level, and at least a portion of the duct's midsection is embedded underground to form the underground duct section (105B), which is then connected to the indoor space (I.S).

The depth at which the external cold-air introduction duct system (105) is embedded is generally preferably set to a position of about 90 cm or less from the ground. This depth corresponds to a zone classified below the frost line, which can maintain a relatively stable temperature that is less affected by fluctuations in outdoor air temperature for most of the year. Therefore, embedding the duct at this depth allows for the introduction of relatively cool air without being affected by high external temperatures during the summer, which can help reduce the initial cooling load and lower the indoor temperature more quickly. At the same time, it also has the potential to reduce temperature deviations in the air through the buffering effect of the underground heat source, thereby enhancing the stability and efficiency of the ventilation performance.

By configuring the external cold-air introduction duct system (105) in this manner, it is possible to introduce the cool, fresh air from the cold ground level into the indoor space (I.S) of the building's ground level, performing cooling and ventilation for the initial indoor space of the ground level even during the summer. Additionally, an air transfer duct can be constructed to deliver the fresh cold air supplied from the external ground, which has entered the indoor space (I.S) of the ground level, to the indoor spaces located in the upper levels, namely the 2nd floor, 3rd floor, etc. This allows the freshest air from the ground level, supplied through the underground duct section (105b) below the freezing line, to be distributed and delivered to the indoor spaces of the upper levels, such as the 2nd and 3rd floors, thereby enabling efficient and comfortable cooling through optimal ventilation for all rooms. The ventilated air, while passing through the duct to the winter garden and smart farm, is heated, and ventilation occurs automatically due to buoyancy, potentially eliminating the need for separate power.

In addition, the external cold-air introduction duct system (105) may be configured to include a duct that connects the indoor space of the top floor of the building with the rooftop smart farm (110), allowing air to be supplied from the indoor space of the top floor to the rooftop smart farm (110) for use in crop cultivation.

Meanwhile, the present invention can utilize a warm-air introduction duct that allows indoor air heated by solar energy during the daytime in the winter to flow into the indoor space of the building below the rooftop smart farm (110). In this case, the warm-air introduction duct connecting the rooftop smart farm (110) and the indoor space of the building below must be equipped with a fan module to forcibly transfer the air that is heated and rising within the rooftop smart farm (110) to the indoor space of the building below.

The rooftop smart farm (110) can contribute to increasing the building's water usage to some extent, but this can actually work favorably in terms of energy utilization. The water required for cultivating crops can be reused from the city water used in radiant cooling or can utilize natural inflows such as rainwater, allowing for dual use. In particular, the city water used in radiant cooling absorbs heat from the indoor space and is maintained at a relatively low temperature, making it suitable for temperature control within the farm or soil cooling. This method helps to distribute energy consumption through a circulation system that uses water in multiple stages with a single flow, while also enhancing the efficiency of physical resource utilization and potentially reducing the overall heating and cooling load.

Furthermore, in the present invention, not only the external cold-air introduction duct system (105) but also when constructing large-scale complexes such as urban planning at the unit level or redevelopment, a regional heating and cooling network connecting buildings within the complex is configured. This allows surplus heating and cooling energy from the plus house to be supplied to other buildings connected to general buildings, thereby enabling integrated and efficient energy management for buildings within the complex or village, which can contribute to the creation of a climate-resilient village.

While the present invention has been illustrated and described in connection with preferred embodiments for the purpose of exemplifying the principles of the invention, it is not limited to the configurations and operations as shown and described. Rather, those skilled in the art will readily understand that numerous modifications and variations of the present invention can be made without departing from the spirit and scope of the appended claims. Therefore, all such appropriate changes and modifications, as well as equivalents, should be considered to fall within the scope of the present invention.

### DESCRIPTION OF REFERENCE NUMERALS

1: Radiant heating and cooling system
1′: Radiant heating and cooling system
2: Shading-type photovoltaic power generation system
10: Heat pump heating/cooling water apparatus
11: Heating-water supply pipe
11a: Heating-water supply flow path
12: Heating-water return pipe
13: City-water inlet pipe
14: Domestic-water supply pipe
14a: Domestic-water transfer pipe
15: Radiant heating/cooling piping network
16: Flow path
17: Flow path (related to cooling ventilation)
17a: Cooling ventilation flow path section
20: Heating-water distributor
30: Heating-water collector
40: City-water supply pipe
41: Cooling city-water direct-connection pipe
50a: Thermal-storage unit
50b: Thermal-cooling storage unit
51: Thermal-storage tank
51a: Inlet port
51b: Outlet port
52: Thermal-storage material
60: Photovoltaic heat-exchange module
61: Photovoltaic module main body
62: Photovoltaic panel
63: Embedded pipe
64: Glass cover
70: Cooling ventilation unit
72: Cooling ventilation fan
75: Small hydropower generator
80: Solar cell panel
81: Wall bracket
82: Angle adjustment means
821: Fixed bracket
822: Hinge part
823: Cylinder module
823a: Expansion bar
824: Moving member
825: Guide member
825a: Sliding guide hole
90: Controller
91: Valve control unit
92: Charging control unit
101: Outer window
102: Inner window
103: Upper opening
104: Lower opening
105: External cold-air introduction duct system
105a: Air inlet
105b: Underground duct section
110: Rooftop smart farm
111: Transparent glass section
112: 50%-transmittance photovoltaic panel module
114: Battery
A1: Indoor heating and cooling area
A2: Domestic-water usage point
IS: Indoor space
wg: Warm-air retention chamber (winter garden)
v1: Heating-water supply valve
v2: Heating-water return valve
v3: Cooling city-water supply valve
v4: Domestic-water supply valve
v5: Heating city-water supply valve

What is claimed is:

1. A building integrated clean energy based ecological plus energy building system, comprising:
a radiant heating and cooling system, including:
a heat pump heating/cooling water apparatus configured to heat incoming water to generate heating water, the apparatus being provided with a city-water inlet pipe, a domestic-water supply pipe, a heating-water supply pipe, and a heating-water return pipe;
a heating-water distributor connected to the heating-water supply pipe and configured to distribute the heating water to a radiant heating/cooling piping network comprising a floor-embedded pipe, a wall-embedded pipe, or a ceiling-embedded pipe;
a heating-water collector configured to supply the heating water, having passed through the radiant heating/cooling piping network, to the heating-water return pipe;
a city-water supply pipe connected to the city-water inlet pipe and configured to supply city water to the heat pump heating/cooling water apparatus;
a cooling city-water direct-connection pipe configured to directly connect the city-water supply pipe to the heating-water distributor such that the city water is directly supplied to the radiant heating/cooling piping network to perform indoor radiant cooling during summertime; and
a domestic-water transfer pipe connecting the domestic-water supply pipe to a domestic-water usage point so as to transfer domestic water from the heat pump heating/cooling water apparatus to the domestic-water usage point;
and a shading-type photovoltaic power generation system installed on an exterior wall of a building in an eave-like form inclined at a predetermined angle, the photovoltaic power generation system being configured to supply, as power required for driving the heat pump and operating the radiant heating and cooling system, electricity generated through solar energy generation, and further to function as a shading device capable of blocking sunlight from entering the interior during summer to reduce a cooling load of the building.

2. The system of claim 1,
wherein the radiant heating and cooling system further comprises a controller configured to:
in summertime, control a flow path such that movement of city water from the city-water supply pipe to the city-water inlet pipe is blocked, and such that the city water is directly supplied to the heating-water distributor through the cooling city-water direct-connection pipe to perform indoor radiant cooling while passing through the radiant heating/cooling piping network and is subsequently returned to the heat pump heating/cooling water apparatus; and
in wintertime, control a flow path such that the heating water heated by the heat pump heating/cooling water apparatus is supplied to the heating-water distributor through the heating-water supply pipe to perform indoor radiant heating while passing through the radiant heating/cooling piping network and is subsequently returned to the heat pump heating/cooling water apparatus.

3. The system of claim 2,
that the city water recovered by the heat pump heating/cooling water apparatus is supplied to the domestic-water transfer pipe through the domestic-water supply pipe so as to be used as domestic water.

4. The system of claim 1,
further comprising a cooling ventilation unit disposed on a connection flow path connecting the radiant heating/cooling piping network and the heating-water collector, the cooling ventilation unit being configured to perform radiant cooling ventilation for an interior by enabling air-cooling heat exchange between the city water moving from the radiant heating/cooling piping network to the heating-water collector and ambient air in summertime.

5. The system of claim 1,
further comprising a thermal-storage unit provided on a heating-water supply flow path connecting the heat pump heating/cooling water apparatus and the heating-water distributor, the thermal-storage unit including a thermal-storage material configured to absorb heat from the heating water passing through the heating-water supply flow path and store thermal energy.

6. The system of claim 1,
further comprising a photovoltaic heat-exchange module configured to include:
a photovoltaic module main body provided with a photovoltaic panel that collects solar heat on its front surface; and
an embedded pipe having one end connected to the city-water supply pipe and another end connected to the city-water inlet pipe, the embedded pipe being embedded in the photovoltaic module main body in close contact with the photovoltaic panel such that heat exchange occurs between the photovoltaic panel and the embedded pipe,
whereby heat collected by the photovoltaic panel is heat-exchanged with the embedded pipe so as to heat the city water flowing through the embedded pipe.

7. The system of claim 1,
wherein the shading-type photovoltaic power generation system comprises a bifacial photovoltaic panel capable of generating electricity on both a front surface and a rear surface, and the bifacial photovoltaic panel is installed in an eave-like inclined form on exterior walls of each floor of a building so as to perform a shading function in addition to a power-generation function.

8. The system of claim 7,
wherein, among two vertically adjacent bifacial photovoltaic panels installed on an exterior wall of the building, a portion of sunlight incident on a front surface of a lower bifacial photovoltaic panel is reflected and incident onto a rear surface of the lower bifacial photovoltaic panel, such that electricity generation occurs on both the front surface and the rear surface of the two vertically adjacent bifacial photovoltaic panels.

9. The system of claim 1,
further comprising an external cold-air introduction duct system configured to introduce fresh outdoor air from a ground-level area of the building and supply to an indoor space fresh cold air produced while the outdoor air passes through an underground duct located below a frost line.

10. The system of claim 1,
further comprising a warm-air retention chamber configured by forming a double-window structure spaced apart from an exterior wall of the building at a predetermined distance, the warm-air retention chamber being configured to block heat loss of an indoor space and warm indoor air by heating air with solar heat during wintertime,
wherein upper and lower openings are formed on an interior-side inner wall of the warm-air retention chamber such that warm air flows into the indoor space by buoyancy caused by a density difference during winter, thereby warming air inside the indoor space.

11. The system of claim 1,
wherein a rooftop smart farm formed as a glass greenhouse is integrally provided on a rooftop of the building,
the rooftop smart farm having an exterior skin configured as a 50%-transmittance photovoltaic panel module in which photovoltaic panels covering 50% of an entire area are installed on side walls and a roof surface of the glass greenhouse,
the rooftop smart farm being configured to use rainwater or city water recovered after performing indoor radiant cooling as water required for cultivating crops,
and the rooftop smart farm further comprising a warm-air introduction duct configured such that, during daytime in winter, indoor air of the farm heated by solar heat is introduced into an interior of the building below the rooftop smart farm so as to perform indoor heating during winter.
